(19) United States
(12) Patent Application Publication
(10) Pub. No.: US 2012/0023138 A1
(43) Pub. Date: Jan. 26, 2012

(54) DELETING OBJECTS WITH GROUP AUTHORITY

(75) Inventors: Randy L. Egan, Rochester, MN (US); Rafal P. Konik, Oronoco, MN (US); Roger A. Mittelstadt, Byron, MN (US); Mark W. Theuer, Rochester, MN (US)

(73) Assignee: INTERNATIONAL BUSINESS MACHINES CORPORATION, Armonk, NY (US)

(21) Appl. No.: 12/843,434

(22) Filed: Jul. 26, 2010

(51) Int. Cl. G06F 17/30

(52) U.S. Cl. 707/783; 707/813; 707/E17.005

(57) ABSTRACT

In an embodiment, a command is received from a sender that requests deletion of an object. A determination is made whether the object specifies group authority and whether all of a plurality of members of the group authority have requested deletion of the object. If the object specifies group authority and all of the plurality of members of the group authority have requested deletion of the object, then the object is deleted. If the object specifies group authority and not all of the plurality of members of the group authority have requested deletion of the object, then an indication is saved in the group authority that the sender requested deletion of the object. If the object does not specify group authority, then the object is deleted.

### FIELD

An embodiment of the invention generally relates to computer systems and more particularly to the deletion of objects in computer systems.

### BACKGROUND

Computer systems typically comprise a combination of computer programs and hardware, such as semiconductors, transistors, chips, circuit boards, storage devices, and processors. The computer programs are stored in the storage devices and are executed by the processors. Fundamentally, computer systems are used for the storage, manipulation, and analysis of data.

Data in computer systems is typically organized into units or entities that are capable of being accessed or manipulated via computer system functions. An example of such an entity is called an object. Computer systems typically protect objects via the granting and revoking of authority or permission to users to perform functions on the objects, such as reading from, writing to, and/or deleting the objects. For each object, the computer system may grant this authority to one or more users.

### SUMMARY

A method, computer-readable storage medium, and computer system are provided. In an embodiment, a command is received from a sender that requests deletion of an object. A determination is made whether the object specifies group authority and whether all of a plurality of members of the group authority have requested deletion of the object. If the object specifies group authority and all of the plurality of members of the group authority have requested deletion of the object, then the object is deleted. If the object specifies group authority and not all of the plurality of members of the group authority have requested deletion of the object, then an indication is saved in the group authority that the sender requested deletion of the object. If the object does not specify group authority, then the object is deleted.

### BRIEF DESCRIPTION OF THE SEVERAL VIEWS OF THE DRAWINGS

FIG. 1 depicts a high-level block diagram of an example system for implementing an embodiment of the invention.

FIG. 2 depicts a block diagram of an example user interface displayed on a display device.

FIG. 3 depicts a block diagram of example objects, according to an embodiment of the invention.

FIG. 4 depicts a block diagram of example group profiles, according to an embodiment of the invention.

FIG. 5 depicts a flowchart of example processing for commands, according to an embodiment of the invention.

FIG. 6 depicts a flowchart of example processing for a drop command, according to an embodiment of the invention.

It is to be noted, however, that the appended drawings illustrate only example embodiments of the invention, and are therefore not considered a limitation of the scope of other embodiments of the invention.

### DETAILED DESCRIPTION

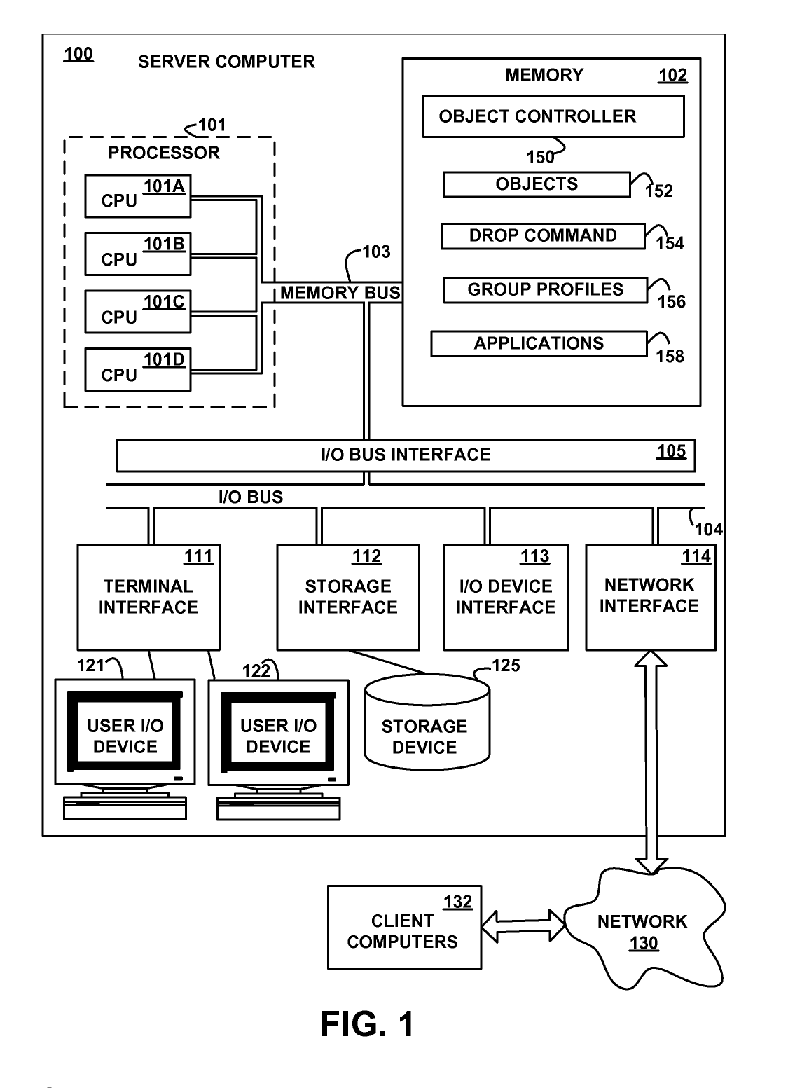

Referring to the Drawings, wherein like numbers denote like parts throughout the several views, FIG. 1 depicts a high-level block diagram representation of a computer system 100 connected to client computer systems 132 via a network 130, according to an embodiment of the invention. The major components of the computer system 100 include one or more processors 101, memory 102, a terminal interface unit 111, a storage interface unit 112, an I/O (Input/Output) device interface unit 113, and a network adapter 114, all of which are communicatively coupled, directly or indirectly, for inter-component communication via a memory bus 103, an I/O bus 104, and an I/O bus interface unit 105.

The processor 101 comprises one or more general-purpose programmable central processing units (CPUs) 101A, 101B, 101C, and 101D. In an embodiment, the computer system 100 comprises multiple processors typical of a relatively large system; however, in another embodiment the computer system 100 may alternatively be a single processor system. The processor 101 executes instructions stored in the memory 102 and/or an on-board cache. The memory 102 may be a random-access semiconductor memory, storage device, or storage medium for storing or encoding data and programs. In another embodiment, the memory 102 may represent the entire virtual memory of the computer system 100, and may also include the virtual memory of other computer systems coupled to the computer system 100 or connected via the network 130. The memory 102 is conceptually a single monolithic entity, but in other embodiments the memory 102 is a more complex arrangement, such as a hierarchy of caches and other memory devices. For example, memory may exist in multiple levels of caches, and these caches may be further divided by function, so that one cache holds instructions while another holds non-instruction data, which is used by the processor or processors. Memory may be further distributed and associated with different CPUs or sets of CPUs, as is known in any of various so-called non-uniform memory access (NUMA) computer architectures.

The memory 102 stores or encodes an object controller 150, objects 152, a drop command 154, group profiles 156, and applications 158. Although the object controller 150, the objects 152, the drop command 154, the group profiles 156, and the applications 158 are illustrated as being contained within the memory 102 in the computer system 100, in other embodiments some or all of them may be on different computer systems (e.g., the client computers 132) and may be accessed remotely, e.g., via the network 130. The computer system 100 may use virtual addressing mechanisms that allow the programs of the computer system 100 to behave as if they only have access to a large, single storage entity instead of access to multiple, smaller storage entities. Thus, while the object controller 150, the objects 152, the drop command 154, the group profiles 156, and the applications 158 are illustrated as being contained within the memory 102, these elements are not necessarily all completely contained in the same storage device at the same time. Further, although the object controller 150, the objects 152, the drop command 154, the group profiles 156, and the applications 158 are illustrated as being separate entities, in other embodiments some of them, portions of some of them, or all of them may be packaged together.

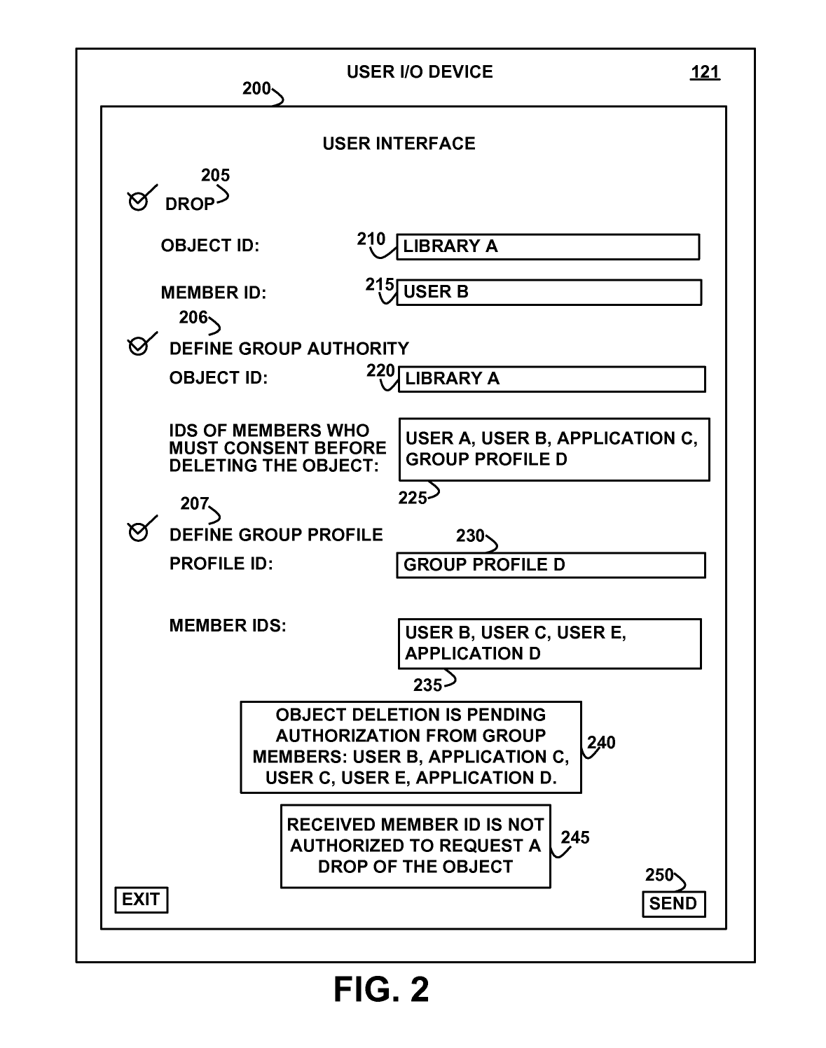

In various embodiments, the object controller 150 and the applications 158 comprise programs, functions, methods, procedures, routines, classes, instructions, or statements that execute on the processor 101 or that are interpreted by instructions or statements that execute on the processor 101, or that are compiled into instructions that execute on the processor 101, to carry out the functions as further described below with reference to FIGS. 2, 3, 4, 5, and 6. In other embodiments, some or all of the object controller 150 and the applications 158 are implemented in hardware via semiconductor devices, chips, logical gates, circuits, circuit cards, and/or other physical hardware devices in lieu of, or in addition to, a processor-based system. In various embodiments, the applications 158 may be user applications, third-party applications, operating systems, functions or operations, or any portion, multiple, or combination thereof.

In various embodiments, the objects 152 may comprise data rows or records, databases, files, data structures, libraries, tables, directories, subdirectories, catalogs, values, functions, logs, executable instructions, interpretable statements, queries, commands, numbers, characters, any entity or unit capable of being manipulated, any other appropriate data, or any portion, multiple, or combination thereof.

The memory bus 103 provides a data communication path for transferring data between the processor 101, the memory 102, and the I/O bus interface unit 105. The I/O bus interface unit 105 is further coupled to the system I/O bus 104 for transferring data to and from the various I/O units. The I/O bus interface unit 105 communicates with multiple I/O interface units 111, 112, 113, and 114, which are also known as I/O processors (IOPs) or I/O adapters (IOAs), through the system I/O bus 104.

The I/O interface units support communication with a variety of storage and I/O devices. For example, the terminal interface unit 111 supports the attachment of one or more user input/output devices 121 and 122, which may include user output devices (such as a video display device, speaker, printer, and/or television set) and user input devices (such as a keyboard, mouse, keypad, touchpad, trackball, buttons, light pen, or other pointing device). A user may manipulate the user input devices, in order to provide input to the user input/output device 121 and 122 and the computer system 100 via a user interface, and may receive output via the user output devices. For example, a user interface may be presented via the user input/output device 121 and 122, such as displayed on a display device, played via a speaker, or printed via a printer.

The storage interface unit 112 supports the attachment of one or more direct access storage devices 125 (which are typically rotating magnetic disk drive storage devices, although they could alternatively be other devices, including arrays of disk drives configured to appear as a single large storage device to a host). In another embodiment, the storage devices 125 may be implemented via any type of secondary storage device. The contents of the memory 102, or any portion thereof, may be stored to and retrieved from the storage devices 125, as needed. The I/O device interface 113 provides an interface to any of various other input/output devices or devices of other types, such as printers or fax machines. The network adapter 114 provides one or more communications paths from the computer system 100 to other digital devices and computer systems; such paths may include, e.g., one or more networks 130.

Although the memory bus 103 is shown in FIG. 1 as a relatively simple, single bus structure providing a direct communication path between the processors 101, the memory 102, and the I/O bus interface unit 105, in fact the memory bus 103 may comprise multiple different buses or communication paths, which may be arranged in any of various forms, such as point-to-point links in hierarchical, star or web configurations, multiple hierarchical buses, parallel and redundant paths, or any other appropriate type of configuration. Furthermore, while the I/O bus interface 105 and the I/O bus 104 are shown as single respective units, the computer system 100 may, in fact, contain multiple I/O bus interface units 105 and/or multiple I/O buses 104. While multiple I/O interface units are shown, which separate the system I/O bus 104 from various communications paths running to the various I/O devices, in other embodiments some or all of the I/O devices are connected directly to one or more system I/O buses.

In various embodiments, the computer system 100 may be a multi-user mainframe computer system, a single-user system, or a server or similar device that has little or no direct user interface, but receives requests from other computer systems (clients). In other embodiments, the computer system 100 may be implemented as a desktop computer, portable computer, laptop or notebook computer, tablet computer, pocket computer, telephone, pager, automobile, teleconferencing system, appliance, or any other appropriate type of electronic device.

The network 130 may be any suitable network or combination of networks and may support any appropriate protocol suitable for communication of data and/or code to/from the computer system 100. In various embodiments, the network 130 may represent a storage device or a combination of storage devices, either connected directly or indirectly to the computer system 100. In an embodiment, the network 130 may support wireless communications. In another embodiment, the network 130 may support hard-wired communications, such as a telephone line or cable. In an embodiment, the network 130 may be the Internet and may support IP (Internet Protocol). In various embodiments, the network 130 may be a local area network (LAN), a wide area network (WAN), a hotspot service provider network, an intranet, a GPRS (General Packet Radio Service) network, a FRS (Family Radio Service) network, a cellular data network, or a cell-based radio network. Although one network 130 is shown, in other embodiments any number of networks (of the same or different types) may be present. The client computers 132 may comprise various combinations of some or all of the hardware and program components of the computer system 100.

FIG. 1 is intended to depict the representative major components of the computer system 100 and the network 130. But, individual components may have greater complexity than represented in FIG. 1, components other than or in addition to those shown in FIG. 1 may be present, and the number, type, and configuration of such components may vary. Several particular examples of such additional complexity or additional variations are disclosed herein; these are by way of example only and are not necessarily the only such variations. The various program components illustrated in FIG. 1 and implementing various embodiments of the invention may be implemented in a number of manners, including using various computer applications, routines, components, programs, objects, modules, data structures, etc., and are referred to hereinafter as “computer programs,” or simply “programs.” The computer programs comprise one or more instructions or statements that are resident at various times in various memory and storage devices in the computer system 100 and that, when read and executed by one or more processors in the computer system 100 or when interpreted by instructions that are executed by one or more processors, cause the computer system 100 to perform the actions necessary to execute steps or elements comprising the various aspects of embodiments of the invention. Aspects of embodiments of the invention may be embodied as a system, method, or computer program product. Accordingly, aspects of embodiments of the invention may take the form of an entirely hardware embodiment, an entirely program embodiment (including firmware, resident programs, micro-code, etc., which are stored in a storage device) or an embodiment combining program and hardware aspects that may all generally be referred to herein as a “circuit,” “module,” or “system.” Further, embodiments of the invention may take the form of a computer program product embodied in one or more computer-readable medium(s) having computer-readable program code embodied thereon.

Any combination of one or more computer-readable medium(s) may be utilized. The computer-readable medium may be a computer-readable signal medium or a computer-readable storage medium. A computer-readable storage medium, may be, for example, but not limited to, an electronic, magnetic, optical, electromagnetic, infrared, or semiconductor system, apparatus, or device, or any suitable combination of the foregoing. More specific examples (an non-exhaustive list) of the computer-readable storage media may comprise: an electrical connection having one or more wires, a portable computer diskette, a hard disk (e.g., the storage device 125), a random access memory (RAM) (e.g., the memory 102), a read-only memory (ROM), an erasable programmable read-only memory (EPROM) or Flash memory, an optical fiber, a portable compact disc read-only memory (CD-ROM), an optical storage device, a magnetic storage device, or any suitable combination of the foregoing. In the context of this document, a computer-readable storage medium may be any tangible medium that can contain, or store, a program for use by or in connection with an instruction execution system, apparatus, or device.

A computer-readable signal medium may comprise a propagated data signal with computer-readable program code embodied thereon, for example, in baseband or as part of a carrier wave. Such a propagated signal may take any of a variety of forms, including, but not limited to, electro-magnetic, optical, or any suitable combination thereof. A computer-readable signal medium may be any computer-readable medium that is not a computer-readable storage medium and that communicates, propagates, or transports a program for use by, or in connection with, an instruction execution system, apparatus, or device. Program code embodied on a computer-readable medium may be transmitted using any appropriate medium, including but not limited to, wireless, wire line, optical fiber cable, Radio Frequency (RF), or any suitable combination of the foregoing.

Computer program code for carrying out operations for aspects of embodiments of the present invention may be written in any combination of one or more programming languages, including object oriented programming languages and conventional procedural programming languages. The program code may execute entirely on the user's computer, partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). Aspects of embodiments of the present invention are described below with reference to flowchart illustrations and/or block diagrams of methods, apparatus (systems), and computer program products. Each block of the flowchart illustrations and/or block diagrams, and combinations of blocks in the flowchart illustrations and/or block diagrams may be implemented by computer program instructions embodied in a computer-readable medium. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified by the flowchart and/or block diagram block or blocks. These computer program instructions may also be stored in a computer-readable medium that can direct a computer, other programmable data processing apparatus, or other devices to function in a particular manner, such that the instructions stored in the computer-readable medium produce an article of manufacture, including instructions that implement the function/act specified by the flowchart and/or block diagram block or blocks. The computer programs defining the functions of various embodiments of the invention may be delivered to a computer system via a variety of tangible computer-readable storage media that may be operatively or communicatively connected (directly or indirectly) to the processor or processors. The computer program instructions may also be loaded onto a computer, other programmable data processing apparatus, or other devices to cause a series of operational steps to be performed on the computer, other programmable apparatus, or other devices to produce a computer-implemented process, such that the instructions, which execute on the computer or other programmable apparatus, provide processes for implementing the functions/acts specified in the flowcharts and/or block diagram block or blocks.

The flowchart and the block diagrams in the figures illustrate the architecture, functionality, and operation of possible implementations of systems, methods, and computer program products, according to various embodiments of the present invention. In this regard, each block in the flowcharts or block diagrams may represent a module, segment, or portion of code, which comprises one or more executable instructions for implementing the specified logical function(s). In some embodiments, the functions noted in the block may occur out of the order noted in the figures. For example, two blocks shown in succession may, in fact, be executed substantially concurrently, or the blocks may sometimes be executed in the reverse order, depending upon the functionality involved. Each block of the block diagrams and/or flowchart illustration, and combinations of blocks in the block diagrams and/or flow chart illustrations, can be implemented by special purpose hardware-based systems that perform the specified functions or acts, in combinations of special purpose hardware and computer instructions.

Embodiments of the invention may also be delivered as part of a service engagement with a client corporation, nonprofit organization, government entity, or internal organizational structure. Aspects of these embodiments may comprise configuring a computer system to perform, and deploying computing services (e.g., computer-readable code, hardware, and web services) that implement, some or all of the methods described herein. Aspects of these embodiments may also comprise analyzing the client company, creating recommendations responsive to the analysis, generating computer-readable code to implement portions of the recommendations, integrating the computer-readable code into existing processes, computer systems, and computing infrastructure, metering use of the methods and systems described herein, allocating expenses to users, and billing users for their use of these methods and systems. In addition, various programs described hereinafter may be identified based upon the application for which they are implemented in a specific embodiment of the invention. But, any particular program nomenclature that follows is used merely for convenience, and thus embodiments of the invention are not limited to use solely in any specific application identified and/or implied by such nomenclature. The exemplary environments illustrated in FIG. 1 are not intended to limit the present invention. Indeed, other alternative hardware and/or program environments may be used without departing from the scope of embodiments the invention.

FIG. 2 depicts a block diagram of an example user interface 200 displayed on a display device of the user input/output device 121. In an embodiment, the user interface 200 is also or alternatively displayed on a display device of the user input/output device 122. The example user interface 200 comprises: a drop command 205 comprising user input fields 210 and 215 for an object identifier and a member identifier, respectively; a define group authority command 206 comprising user input fields 220 and 225 for an object identifier and member identifiers, respectively; a define group profile command 207 comprising user input fields 230 and 235 for a group profile identifier and member identifiers, respectively; messages 240 and 245; and a send command 250. Any, some or all of the drop command 205, the define group authority command 206, and/or the define group profile command 207 may be selected and data input into their respective fields. In response to selection of the send command 250, the user I/O device 121 sends the selected commands 205, 206, and/or 207 and their respective input data to the object controller 150. In another embodiment, the drop command 205, the define group authority command 206, and the define group profile command 207 are sent programmatically by an application or applications 158 in lieu of or in addition to a user interface.

The drop command 205 comprises a request by the member specified in the member identified input identifier field 215 to drop, delete, erase, or remove the object 152 that is specified by the object identifier input field 210 from the memory 102 and/or the storage device 125, so that the object 152 is no longer accessible or readable. The define group authority command 206 comprises a request that the members specified in the member identifiers input field 225 must all consent before the object controller 150 deletes the object specified by the object identifier input field 220. The define group profile command 207 comprises a request that directs the object controller 150 to add the members specified by the group profile member identifiers input field 235 to the group profile 156 specified by the profile identifier identified in the group profile identifier input field 230. The members specified by the group profile member identifiers input field 235 have the authority to represent the group profile identified by the group profile identifier 230 when that group profile is input as a member identifier via the drop command 205 and the deletion of an object is requested.

Thus, using the example of FIG. 2, only one member of the group profile 156 identified by the group profile identifier “group profile D” needs to request deletion of the object “library A,” in order for the object controller 150 to deem that the member “group profile D” of the group authority for the object “library A” has requested deletion of the object “library A.” Thus, in order for the object controller 150 to delete the object “library A,” at a minimum, “user A,” “user B,” “application C,” and any one member of “group profile D” must request deletion. In an embodiment members of a group authority are also allowed to be members of a group profile 156 that is a member of that group authority. In the example of FIG. 2, “user B” is both a member of the group authority for “library A” and is also a member of the “group profile D,” which is a member of the group authority for the library A. Hence, if “user B” requests deletion of the object “library A” via a drop command, then that drop command from “user B” satisfies both the requirement that “user B” must request deletion (as “user B” is a member of the group authority) and the requirement that the “group profile D” must request deletion (as “user B” is a member of the group profile, which is a member of the group authority), in order for the object controller 150 to delete the object “library A.”

The message 240 communicates that the object identified by the object identifier input field 210 of the drop command 205 was not deleted and deletion is pending until all members of the group authority (who must consent in order to delete the object), give authorization or request deletion of the object. In an embodiment, the message 240 comprises identifiers of the members who have not yet requested that the object be deleted. The message 245 communicates that the member identified by the member identifier input field 215 is not a member of the group authority (who have the authority to request deletion of the object), so the object specified by the input field 210 was not deleted in response to the drop command 205.

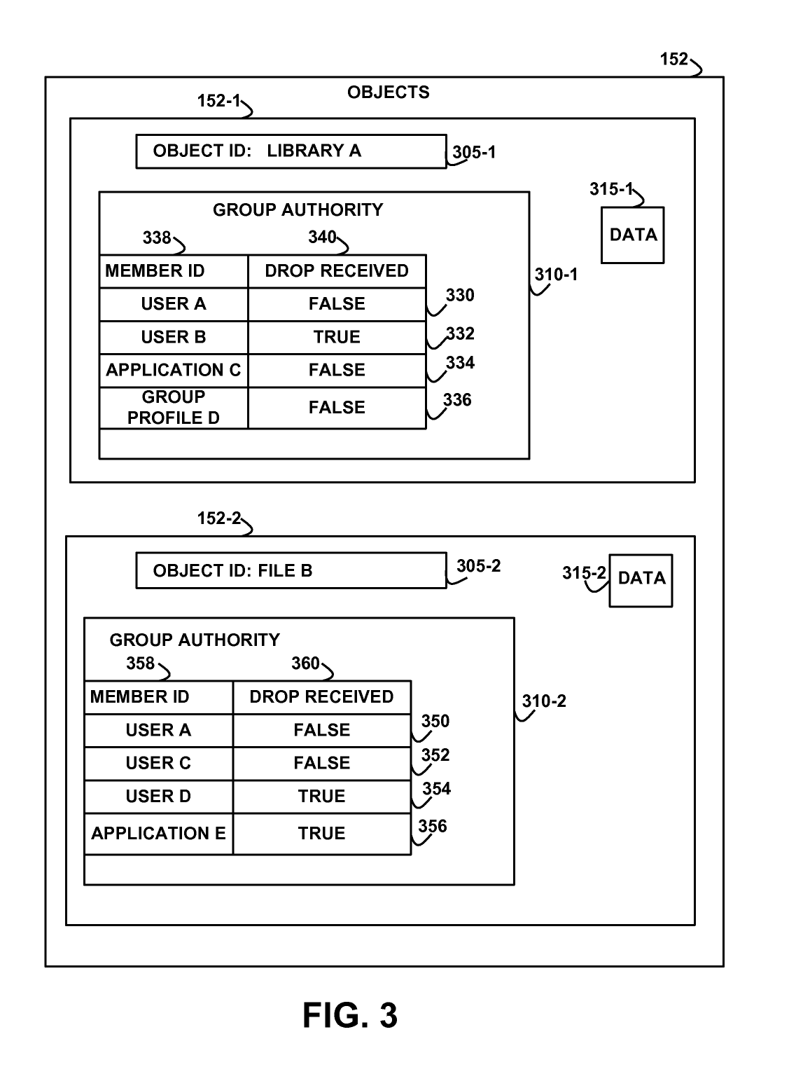

FIG. 3 depicts a block diagram of example objects 152, according to an embodiment of the invention. The example objects 152 comprise objects 152-1 and 152-2. The object 152-1 comprises an object identifier 305-1, group authority 310-1, and data 315-1. The object identifier 305-1 uniquely identifies or names the object 152-1. The group authority 310-1 comprises entries 330, 332, 334, and 336, each of which comprises member identifiers 338 that uniquely identify members who are authorized to request the deletion of the object 152-1 and a drop received field 340 that indicates, for each entry, whether or not that the respective member identified by the respective member identifier 338 has requested deletion of the object 152-1 via a drop command 205. The group authority 310-1 is optional and does not exist for objects for which the object controller 150 has not received a define group authority command 206. The example entry 330 illustrates that the member identified by the member identifier of “user A” has not requested deletion of the object 152-1. The example entry 332 illustrates that the member identified by the member identifier of “user B” has requested deletion of the object 152-1. The example entry 334 illustrates that the member identified by the member identifier of “application C” has not requested deletion of the object 152-1. The entry 336 illustrates that the member identified by the member identifier “group profile D” has not requested deletion of the object 152-1, meaning that none of the members of the group profile D have requested deletion of the object 152-1.

The object 152-2 comprises an object identifier 305-2, group authority 310-2, and data 315-2. The object identifier 305-2 uniquely identifies the object 152-2. The group authority 310-2 comprises entries 350, 352, 354, and 356, each of which comprises member identifiers 358 that uniquely identify members who are authorized to request the deletion of the object 152-2 and a drop received field 360 that indicates, for each entry, whether or not that the respective member identified by the member identifier 358 has requested deletion of the object 152-2.

The example entry 350 illustrates that the member identified by the member identifier of “user A” has not requested deletion of the object 152-2. The example entry 352 illustrates that the member identified by the member identifier of “user C” has not requested deletion of the object 152-2. The entry 354 illustrates that the member identified by the member identifier of “user D” has requested deletion of the object 152-2. The example entry 356 illustrates that the member identified by the member identifier “application E” has requested deletion of the object 152-2.

Although the group authority 310-1 and 310-2 are illustrated as being contained within the respective objects 152-1 and 152-2, in another embodiment, the group authority 310-1 and 310-2 are implemented outside of the respective object, and the respective object comprises a pointer, address, or identifier that identifies the group authority 310-1 or 310-2 that controls the authority to delete the object

In various embodiments, the member identifiers 338 and 358 may identify users, applications 158, group profiles 156, or any combination or multiple thereof. In various embodiments, member identifiers 338 and 358 may be identifiers or names of users or applications or pointers, addresses, or identifiers of objects that represent the users or pointers, addresses or identifiers of the applications in memory or a storage device. The data 315-1 comprises the data represented by the object 152-1, and the data 315-2 comprises the data represented by the object 152-2. In various embodiments, the data 315-1 and/or 315-2 may comprise a data row or record, a database, a table, a file, a data structure, a library, a directory, a subdirectory, a catalog, a value, a function, a log, executable instructions, interpretable statements, queries, commands, numbers, characters, any entity or unit capable of being manipulated, any other appropriate data, or any portion, multiple, or combination thereof.

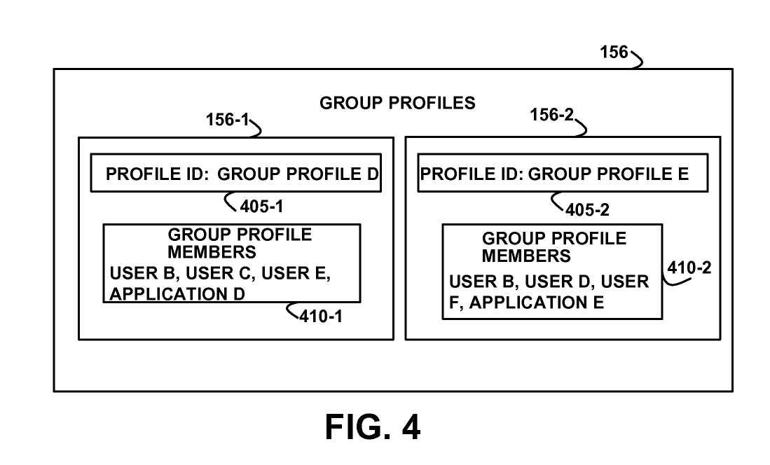

FIG. 4 depicts a block diagram of example group profiles 156, according to an embodiment of the invention. The group profiles 156 comprise example group profiles 156-1 and 156-2. The example group profile 156-1 comprises a profile identifier field 405-1 and a group members field 410-1. The profile identifier field 405-1 comprises an identifier or name that uniquely identifies the group profile 156-1. The group members field 410-1 comprises identifiers or names of the members of the groups or of objects or data structures that represent the members of the group profile 156-1. The example group profile 156-2 comprises a profile identifier field 405-2 and a group members field 410-2. The profile identifier field 405-2 comprises an identifier or name that uniquely identifies the group profile 156-2. The group members field 410-1 comprises identifiers or names of the members of the groups or of objects or data structures that represent the members of the group profile 156-2. The members of the group profiles 156-1 and 156-2 may be users or applications 158.

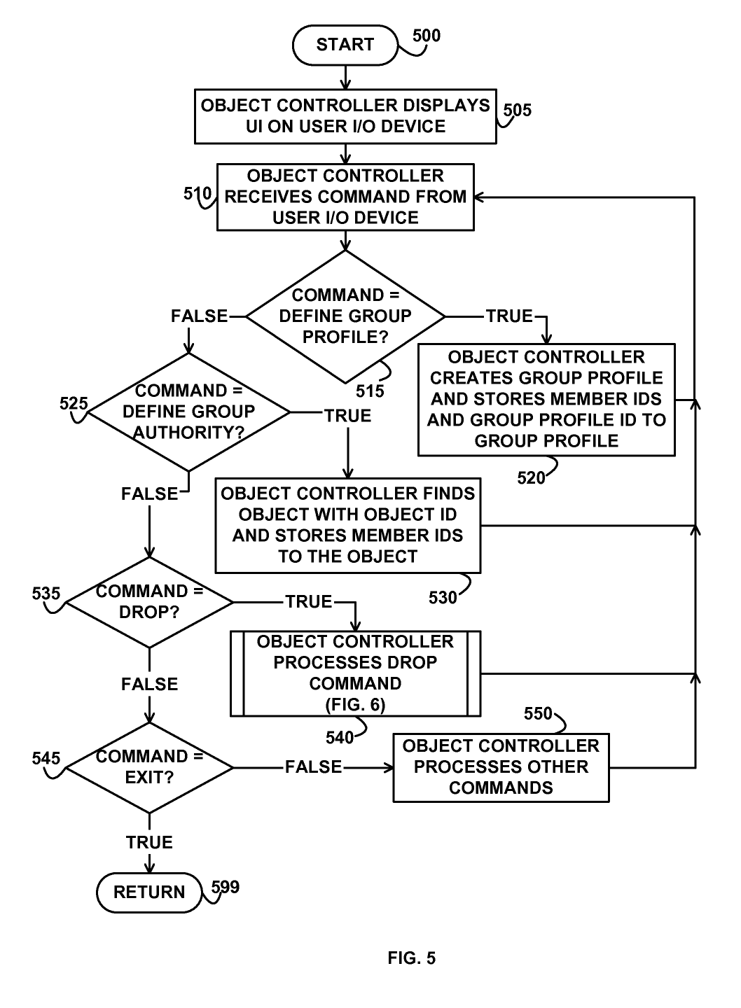

FIG. 5 depicts a flowchart of example processing for commands, according to an embodiment of the invention. Control begins at block 500. Control then continues to block 505 where the object controller 150 displays the user interface 200 on the display device of the user I/O device 121 and/or 122. Control then continues to block 510 where the object controller 150 receives a command from the user I/O device 121 or 122. In an embodiment, the object controller 150 stores the received command to the memory 102. In an embodiment, the object controller 150 receives the command from any appropriate sender, such as an application 158, the client computer 132 via the network 130, or a user via the user I/O device 121 or 122. Control then continues to block 515 where the object controller 150 determines whether the received command is a define group profile command 207.

If the determination at block 515 is true, then the received command is the define group profile command 207, so control continues to block 520 where the object controller 150 creates a group profile 156-1 or 156-2 in the group profiles 156 and stores the group profile identifier and the member identifiers specified by the received group profile command 207 to the group profile identifier 405-1 or 405-2 and the group profile members 410-1 or 410-2 in the created group profiles 156-1 or 156-2. Control then returns to block 510 where the object controller 150 receives the same or a different command from the same or a different sender, as previously described above. If the determination at block 515 is false, then the received command is not the define group profile command 207, so control continues to block 525 where the object controller 150 determines whether the received command is the define group authority command 206. If the determination at block 525 is true, then the received command is the define group authority command 206, so control continues to block 530 where the object controller 150 finds an object in the objects 152 with an object identifier 305-1 or 305-2 that matches the object identifier specified by the define group authority command 206, stores the member identifiers 225 specified by the define group authority command 206 to the member identifier field 338 or 358 in entries in the group authority 310-1 or 310-2 in the found object 152, and initializes the drop received field 340 or 360 in the added entries in the group authority 310-1 or 310-2 to indicate false, indicating that the object controller 150 has not yet received a drop command from those members. Control then returns to block 510 where the object controller 150 receives another the same or a different command from the same or a different sender, as previously described above.

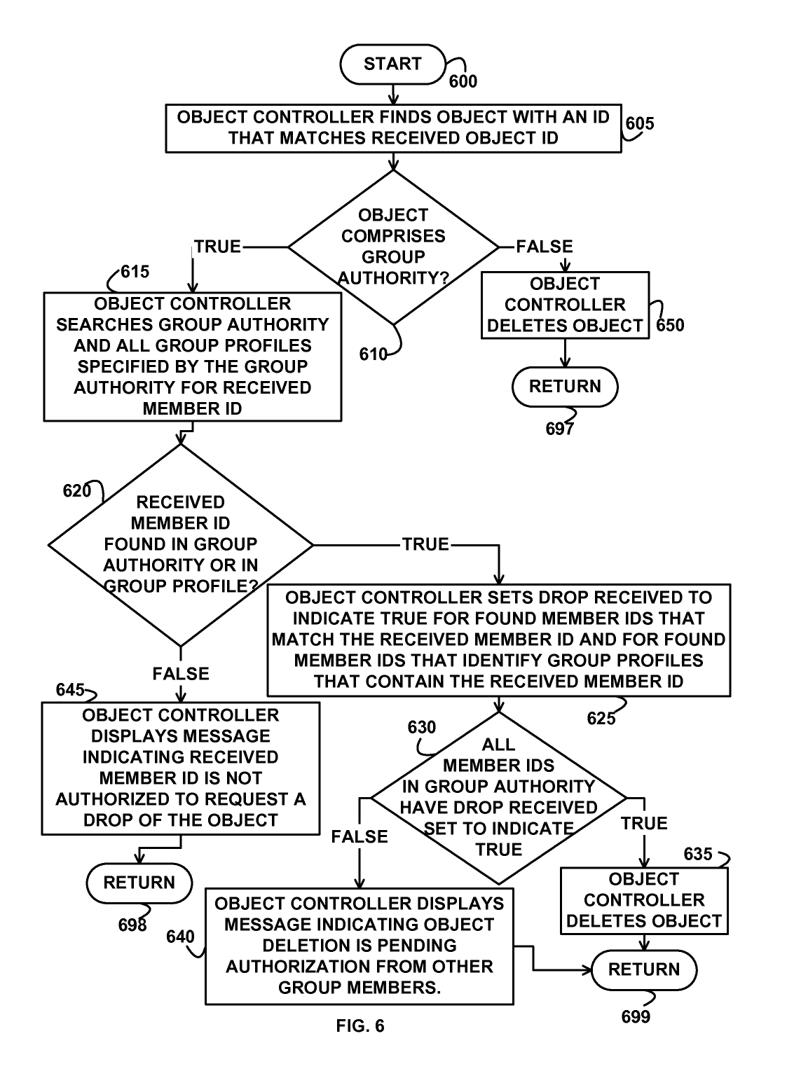

If the determination at block 525 is false, then the received command is not the define group authority command 206, so control continues to block 535 where the object controller 150 determines whether the received command is the drop command 205. If the determination at block 535 is true, then the received command is the drop command 205, so control continues to block 540 where the object controller 150 processes the received drop command 205, as further described below with reference to FIG. 6. Control then returns to block 510 where the object controller 150 receives the same or a different command from the same or a different sender, as previously described above. If the determination at block 535 is false, then the received command is not the drop command 205, so control continues to block 545 where the object controller 150 determines whether the command is an exit command. If the determination at block 545 is true, then the received command is an exit command, so control continues to block 599 where the logic of FIG. 5 returns. If the determination at block 545 is false, then control continues to block 550 where the object controller 150 processes other commands, such as commands to modify objects, delete or modify the group authority 310-1 or 310-2, delete or modify the group profiles 156, or any other appropriate commands. Control then returns to block 510 where the object controller 150 receives the same or a different command from the same or a different sender, as previously described above.

FIG. 6 depicts a flowchart of example processing for a drop command, according to an embodiment of the invention. Control begins at block 600. Control then continues to block 605 where the object controller 150 finds the object 152-1 or 152-2 with an object identifier 305-1 or 305-2 that matches (is identical to) the received object identifier 210 specified by the drop command 205. Control then continues to block 610 where the object controller 150 determines whether the found object comprises a group authority data structure 310-1 or 310-2. If the determination at block 610 is true, then the found object comprises a group authority data structure 310-1 or 310-2, so control continues to block 615 where the object controller 150 searches the found group authority 310-1 or 310-2 in the found object and searches all group profiles 156 specified by the found group authority 310-1 or 310-2 for entries with member identifiers 338 or 358 and for group profile member identifiers 410-1 or 410-2 that match the received member identifier 215 specified by the drop command 205. Control then continues to block 620 where the object controller 150 determines whether the received member identifier 25 specified by the drop command 205 matches any member identifier 338 or 358 in the group authority 310-1 or 310-2 or matches any group profile member identifier 410-1 or 410-2 in any group profile 156-1 or 156-2 whose profile identifier 405-1 or 405-2 is specified by the member identifier 338 or 358 in the group authority 310-1 or 310-2.

If the determination at block 620 is true, then the received member identifier 215 specified by the drop command 205 matches a member identifier 338 or 358 in an entry in the group authority 310-1 or 310-2 or matches at least one member identifier in at least one group profile whose profile identifier 405-1 or 405-2 is specified by the member identifier 338 or 358 in an entry in the group authority 310-1 or 310-2, so control continues to block 625 where the object controller 150 sets the drop received field 340 or 360 to indicate true for the found member identifiers 338 or 358 that match the received member identifier specified by the drop command 205 and for the found member identifiers 338 or 358 that identify group profiles 156 that comprise group member identifiers 410-1 or 410-2 that match the received member identifier 215 specified by the drop command 205. Control then continues to block 630 where the object controller 150 determines whether all member identifiers 338 or 358 in entries in the group authority 310-1 or 310-2 of the object 152-1 or 152-2 specified by the received object identifier 210 in the drop command have their drop received fields 340 or 360 set to indicate true, indicating that all members 338 or 358 in the group authority have requested that the object be deleted. If the determination at block 630 is true, then all member identifiers 338 or 358 in the group authority 310-1 or 310-2 of the object have their drop received fields 340 or 360 set to indicate true, indicating that all members have requested that the object be deleted, so control continues to block 635 where the object controller 150 deletes the object identified by the received object identifier 210 of the received drop command 205. Control then continues to block 699 where the logic of FIG. 6 returns to the invoker.

If the determination at block 630 is false, then not all member identifiers 338 or 358 in the group authority 310-1 or 310-2 of the object identified by the object identifier 210 of the received drop command 205 have their drop received fields 340 or 360 set to indicate true, and at least one member has its drop received field 340 or 360 set to indicate false, indicating that not all members have requested that the object be deleted, so control continues to block 640 where the object controller 150 displays a message 240 indicating that object deletion is pending authorization from other group members, and the object controller 150 does not delete the object identified by the received object identifier 215 specified by the drop command 205. Control then continues to block 699 where the logic of FIG. 6 returns to the invoker. If the determination at block 620 is false, then the received member identifier 215 specified by the drop command does not match any of the member identifiers 338 or 358 in entries in the group authority 310-1 or 310-2 of the object requested to be deleted and does not match any of the member identifiers 410-1 or 410-2 in any of the group profiles 156 that are specified by the member identifiers 338 or 358 in the group authority 310-1 or 310-2, so control continues to block 645 where the object controller 150 displays a message 245, indicating that the received member identifier 215 is not authorized to request a drop of the object and that the object is not deleted. Control then continues to block 698 where the logic of FIG. 6 returns to the invoker.

If the determination at block 610 is false, then the found object does not comprise a group authority data structure 310-1 or 310-2, so control continues to block 650 where the object controller 150 deletes the found object from the memory 102 and/or from the storage device 125, as requested by the drop command 205, so that the object controller 150 and/or the applications 158 can no longer read or access the object. Control then continues to block 697 where the logic of FIG. 6 returns to the invoker.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of the stated features, integers, steps, operations, elements, and/or components, but do not preclude the presence or addition of one or more other features, integers, steps, operations, elements, components, and/or groups thereof.

In the previous detailed description of exemplary embodiments of the invention, reference was made to the accompanying drawings (where like numbers represent like elements), which form a part hereof, and in which is shown by way of illustration specific exemplary embodiments in which the invention may be practiced. These embodiments were described in sufficient detail to enable those skilled in the art to practice the invention, but other embodiments may be utilized and logical, mechanical, electrical, and other changes may be made without departing from the scope of the present invention. In the previous description, numerous specific details were set forth to provide a thorough understanding of embodiments of the invention. But, embodiments of the invention may be practiced without these specific details. In other instances, well-known circuits, structures, and techniques have not been shown in detail in order not to obscure embodiments of the invention. Different instances of the word “embodiment” as used within this specification do not necessarily refer to the same embodiment, but they may. Any data and data structures illustrated or described herein are examples only, and in other embodiments, different amounts of data, types of data, fields, numbers and types of fields, field names, numbers and types of rows, records, entries, or organizations of data may be used. In addition, any data may be combined with logic, so that a separate data structure is not necessary. The previous detailed description is, therefore, not to be taken in a limiting sense.

What is claimed is:

1. A method comprising:
receiving a command from a sender that requests deletion of an object;
determining whether the object specifies group authority and whether all of a plurality of members of the group authority have requested deletion of the object;
if the object specifies the group authority and all of the plurality of members of the group authority have requested deletion of the object, deleting the object;
if the object specifies the group authority and not all of the plurality of members of the group authority have requested deletion of the object, saving an indication in the group authority that the sender requested deletion of the object; and
if the object does not specify the group authority, deleting the object.

2. The method of claim 1, wherein the determining whether the object specifies the group authority and whether all of a plurality of the members of the group authority have requested deletion further comprises:
if the group authority specifies that a group profile is one of the plurality of members of the group authority, searching the group profile for an identifier of the sender.

3. The method of claim 2, further comprising:
if the group profile is one of the plurality of members of the group authority, and if the group profile specifies the identifier of the sender, and if not all of the plurality of members of the group authority have requested deletion of the object, saving an indication in the group authority that the group profile requested deletion of the object.

4. The method of claim 3, wherein the sender is a member of the group authority and a member of the group profile.

5. The method of claim 2, further comprising:
if the group profile is one of the plurality of members of the group authority, and if the group profile specifies the identifier of the sender, and if not all of the plurality of members of the group authority have requested deletion of the object, saving an indication in the group authority that the group profile requested deletion of the object.

6. The method of claim 1, further comprising:
if the object specifies the group authority and not all of the plurality of members of the group authority have requested deletion of the object, refraining from deleting the object.

7. The method of claim 1, further comprising:
if the object specifies the group authority and not all of the plurality of members of the group authority have requested deletion of the object, presenting a message indicating that deletion of the object is pending authorization from other of the plurality of members of the group authority.

8. A computer-readable storage medium encoded with instructions, wherein the instructions when executed comprise:
receiving a command from a sender that requests deletion of an object;
determining whether the object specifies group authority and whether all of a plurality of members of the group authority have requested deletion of the object;
if the object specifies the group authority and all of the plurality of members of the group authority have requested deletion of the object, deleting the object;
if the object specifies the group authority and not all of the plurality of members of the group authority have requested deletion of the object, saving an indication in the group authority that the sender requested deletion of the object; and
if the object does not specify the group authority, deleting the object.

9. The computer-readable storage medium of claim 8, wherein the determining whether the object specifies the group authority and whether all of a plurality of the members of the group authority have requested deletion further comprises:
if the group authority specifies that a group profile is one of the plurality of members of the group authority, searching the group profile for an identifier of the sender.

10. The computer-readable storage medium of claim 9, further comprising:
if the group profile is one of the plurality of members of the group authority, and if the group profile specifies the identifier of the sender, and if not all of the plurality of members of the group authority have requested deletion of the object, saving an indication in the group authority that the group profile requested deletion of the object.

11. The computer-readable storage medium of claim 10, wherein the sender is a member of the group authority and a member of the group profile.

12. The computer-readable storage medium of claim 9, further comprising:
if the group profile is one of the plurality of members of the group authority, and if the group profile specifies the identifier of the sender, and if not all of the plurality of members of the group authority have requested deletion of the object, saving an indication in the group authority that the group profile requested deletion of the object.

13. The computer-readable storage medium of claim 8, further comprising:
if the object specifies the group authority and not all of the plurality of members of the group authority have requested deletion of the object, refraining from deleting the object.

14. The computer-readable storage medium of claim 8, further comprising:
if the object specifies the group authority and not all of the plurality of members of the group authority have requested deletion of the object, presenting a message indicating that deletion of the object is pending authorization from other of the plurality of members of the group authority.

15. A computer system, comprising:
a processor; and
memory communicatively coupled to the processor, wherein the memory is encoded with instructions that when executed on the processor comprise:
receiving a command from a sender that requests deletion of an object,
determining whether the object specifies group authority and whether all of a plurality of members of the group authority have requested deletion of the object, wherein the determining whether the object specifies the group authority and whether all of a plurality of the members of the group authority have requested deletion further comprises if the group authority specifies that a group profile is one of the plurality of members of the group authority, searching the group profile for an identifier of the sender,
if the object specifies the group authority and all of the plurality of members of the group authority have requested deletion of the object, deleting the object,
if the object specifies the group authority and not all of the plurality of members of the group authority have requested deletion of the object, saving an indication in the group authority that the sender requested deletion of the object, and
if the object does not specify the group authority, deleting the object.

16. The computer system of claim 15, further comprising:
if the group profile is one of the plurality of members of the group authority, and if the group profile specifies the identifier of the sender, and if not all of the plurality of members of the group authority have requested deletion of the object, saving an indication in the group authority that the group profile requested deletion of the object.

17. The computer system of claim 16, wherein the sender is a member of the group authority and a member of the group profile.

18. The computer system of claim 15, wherein the instructions further comprise:
if the group profile is one of the plurality of members of the group authority, and if the group profile specifies the identifier of the sender, and if not all of the plurality of members of the group authority have requested deletion of the object, saving an indication in the group authority that the group profile requested deletion of the object.

19. The computer system of claim 15, wherein the instructions further comprise:
if the object specifies the group authority and not all of the plurality of members of the group authority have requested deletion of the object, refraining from deleting the object.

20. The computer system of claim 15, wherein the instructions further comprise:
if the object specifies the group authority and not all of the plurality of members of the group authority have requested deletion of the object, presenting a message indicating that deletion of the object is pending authorization from other of the plurality of members of the group authority.
